(19) United States
(12) Patent Application Publication
(10) Pub. No.: US 2016/0283976 A1
(43) Pub. Date: Sep. 29, 2016

(54) METHOD OF ENHANCING THE ACCURACY OF PREDICTING THE GENDER OF NETWORK USERS

(71) Applicant: Appier Inc., Taipei (TW)

(72) Inventors: Che-Hua YEH, Taipei (TW); Chih-Han YU, Taipei (TW); Jyun-Fan TSAI, Taipei (TW); Kai-Yueh CHANG, Taipei (TW); Kuan-Hua LIN, Taipei (TW); Huan-Wen HSIAO, Taipei (TW); Tse-Ju LIN, Taipei (TW)

(21) Appl. No.: 14/669,373

(22) Filed: Mar. 26, 2015

(51) Int. Cl. G06Q 30/02

(52) U.S. Cl. CPC G06Q 30/0255

(57) ABSTRACT

A method of enhancing the accuracy to predict the gender of a network user comprises: obtaining campaign gender distribution ratios for each advertising campaign by counting the gender information of groundtruth devices which clicked in the respective advertising campaigns; assigning the gender information for each unknown device by finding out the advertising campaigns that are clicked by the unknown device, multiplying the campaign gender distribution ratios of the clicked advertising campaigns, and comparing the multiplied result with a first certain value; obtaining update campaign gender distribution ratios for each advertising campaign by counting the gender information of groundtruth devices and unknown devices which clicked in the respective advertising campaigns; and comparing a quadratic sum of the difference of the old and update campaign gender distribution ratios with a second certain value for each advertising campaign, and back to the assigning step if the quadratic sum is greater than a second certain value.

### FIELD OF THE INVENTION

This invention relates to a method of enhancing the accuracy of predicting the gender of network users.

### BACKGROUND OF THE INVENTION

With the growth of web usage, online advertising is growing rapidly in recent years. In order to target specific users with relevant advertisements, advertisers and advertising platform companies would like to know the characteristics of a user, for example, gender. The gender information can be obtained by several ways, for example, when a user filling out the website membership form. The device of such user is hereinafter referred to as “groundtruth device”, and the other device whose user's information is not yet obtained is hereinafter referred to as “unknown device”. The advertisers and advertising platform companies can also predict the user's gender of unknown devices by analyzing his/her website-browsing history or advertisement-clicking pattern. For example, the user may be predicted as female when the device usually browses feminine websites (such as http://womany.net) or clicks feminine advertisement (such as Lancôme makeup advertisement). However, this approach has an accuracy of about only 80% for gender prediction. Therefore, a method of enhancing the accuracy of predicting the gender of network users is needed.

### SUMMARY OF THE INVENTION

The present invention relates to a method of enhancing the accuracy to predict the gender of a network user, comprising the steps of: obtaining campaign gender distribution ratios for each advertising campaign by counting the gender information of groundtruth devices which clicked in the respective advertising campaigns; assigning the gender information for each unknown device by finding out the advertising campaigns that are clicked by the unknown device, multiplying the campaign gender distribution ratios of the clicked advertising campaigns, and comparing the multiplied result with a first certain value; obtaining update campaign gender distribution ratios for each advertising campaign by counting the gender information of groundtruth devices and unknown devices which clicked in the respective advertising campaigns; and comparing a quadratic sum of the difference of the old and update campaign gender distribution ratios with a second certain value for each advertising campaign, and back to the assigning step if the quadratic sum is greater than a second certain value.

In an exemplary embodiment, a given value may be directly assigned to an advertising campaign if the campaign gender distribution ratio of the advertising campaign is abnormal.

### BRIEF DESCRIPTION OF DRAWINGS

The objections, functions, features and advantages of the invention will be appreciated more fully from the following further description thereof with reference to the accompanying drawings wherein:

FIG. 1 shows a flow chart of a method of enhancing the accuracy of predicting the gender of network users according to a preferred embodiment of the present invention.

### DETAILED DESCRIPTION OF SPECIFIC EMBODIMENTS

The following exemplary examples will be described in detail with the appended drawings in order to make the aforementioned objectives, functional features, and advantages more clearly understood.

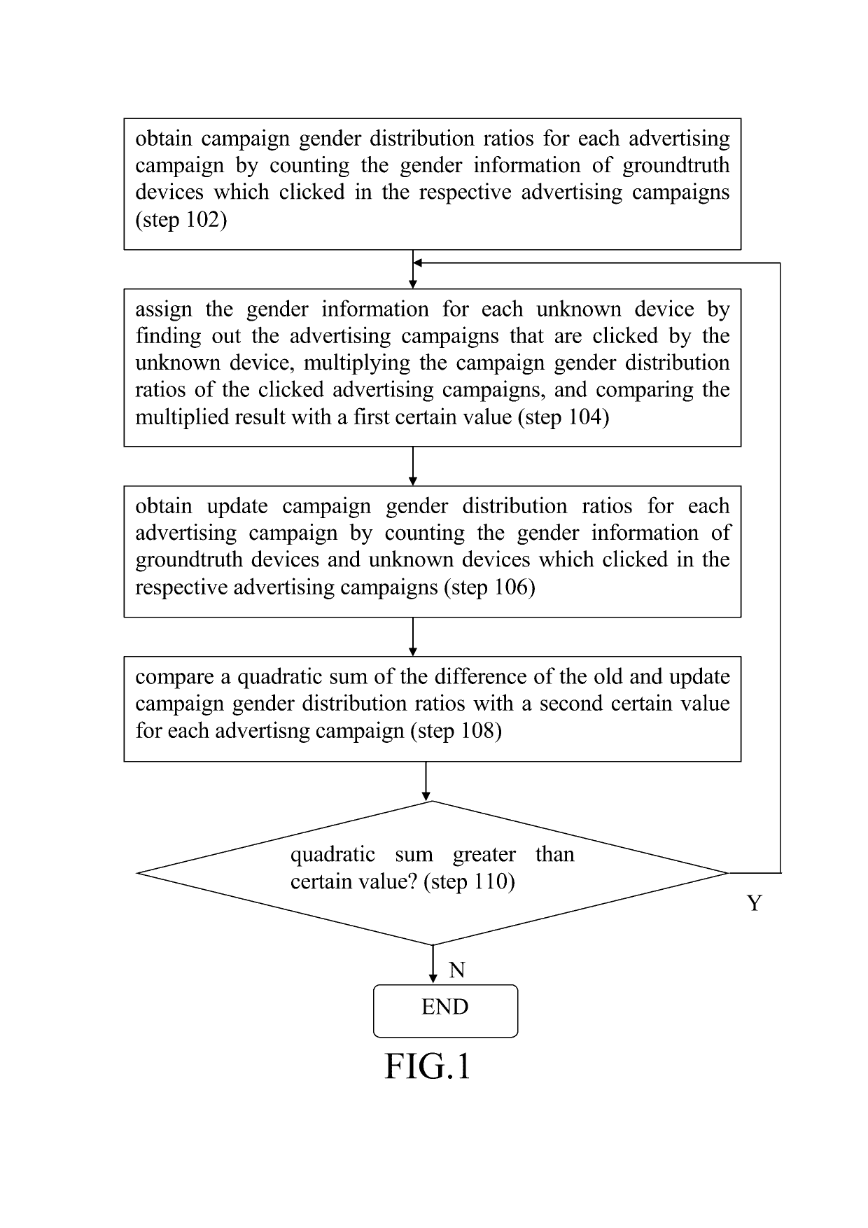

FIG. 1 shows a flow chart of a method of enhancing the accuracy of predicting the gender of network users according to a preferred embodiment of the present invention. A method of enhancing the accuracy to predict the gender of a network user comprises: obtaining campaign gender distribution ratios for each advertising campaign by counting the gender information of groundtruth devices which clicked in the respective advertising campaigns (step 102); assigning the gender information for each unknown device by finding out the advertising campaigns that are clicked by the unknown device, multiplying the campaign gender distribution ratios of the clicked advertising campaigns, and comparing the multiplied result with a first certain value (step 104); obtaining update campaign gender distribution ratios for each advertising campaign by counting the gender information of groundtruth devices and unknown devices which clicked in the respective advertising campaigns (step 106); and comparing a quadratic sum of the difference of the old and update campaign gender distribution ratios with a second certain value for each advertising campaign (step 108), and back to the assigning step if the quadratic sum is greater than a second certain value (step 110).

Steps 102-110 are specifically described as follows.

Step 102: obtain campaign gender distribution ratios for each advertising campaign by counting the gender information of groundtruth devices which clicked in the respective advertising campaigns. Since the gender information of the groundtruth devices is already known, the campaign gender distribution ratio for each advertising campaign can be counted. Take advertising campaign 1 (for example, LANCÔME makeup advertisement; hereinafter, AC1) for example, if there are 200 male and 800 female of groundtruth devices that click AC1, then the campaign gender distribution ratio of AC1 is 200/800=0.25. Take advertising campaign 2 (for example, Gundam animation advertisement; hereinafter, AC2) for example, if there are 750 male and 250 female of groundtruth devices that click AC2, then the campaign gender distribution ratio of AC2 is 750/250=3. Take advertising campaign 3 (for example, Nike sport shoes advertisement; hereinafter, AC3) for example, if there are 600 male and 400 female of groundtruth devices that click AC3, then the campaign gender distribution ratio of AC3 is 600/400=1.5. Take advertising campaign 4 (for example, Gucci perfume advertisement; hereinafter, AC4) for example, if there are 400 male and 800 female of groundtruth devices that click AC4, then the campaign gender distribution ratio of AC4 is 400/800=0.5. In this manner, the campaign gender distribution ratios for each advertising campaign can be obtained.

Step 104: assign the gender information for each unknown device by finding out the advertising campaigns that are clicked by the unknown device, multiplying the campaign gender distribution ratios of the clicked advertising campaigns, and comparing the multiplied result with a first certain value. For example, if unknown device 1 (hereinafter UD1) only clicks AC1 and AC3, then the campaign gender distribution ratios of AC1 and AC3 (which is 0.25 and 1.5, respectively) are used to calculate (0.25 multiplied by 1.5) to obtain a calculated result (which is 0.375). Assume a neutral advertising campaign has equal male-female ratio, then its campaign gender distribution ratio is 1 (i.e., the above-mentioned first certain value). Therefore, it is advised to define that the advertising campaign whose campaign gender distribution ratio is greater than 1 is for male, and less than 1 is for female. Since 0.375 is less than 1, the gender information for the user of UD1 is then assigned to be female in this case. In another case, if unknown device 2 (hereinafter UD2) only clicks AC2 and AC3, then the campaign gender distribution ratios of AC2 and AC3 (which is 3 and 1.5, respectively) are used to calculate (3 multiplied by 1.5) to obtain a calculated result (which is 4.5). Since 4.5 is greater than 1, the gender information for the user of UD2 is then assigned to be male in this case. In this manner, the gender information of the user of all the unknown devices can be assigned.

Step 106: obtain update campaign gender distribution ratios for each advertising campaign by counting the gender information of groundtruth devices and unknown devices which clicked in the respective advertising campaigns. For example, it is assumed that for all the devices that click AC1, there are 200 groundtruth devices whose users are male, 800 groundtruth devices whose users are female, 16000 unknown devices whose users are male, and 60000 unknown devices whose users are female according to the above-mentioned steps, then there are 16200 devices whose users are male and 60800 devices whose users are female, and the update campaign gender distribution ratio of AC1 is 16200/60800=0.26. In another case, it is assumed that for all the devices that click AC2, there are 750 groundtruth devices whose users are male, 250 groundtruth devices whose users are female, 10000 unknown devices whose users are male, and 3000 unknown devices whose users are female according to the above-mentioned steps, then there are 10750 devices whose users are male and 3250 devices whose users are female, and the update campaign gender distribution ratio of AC2 is 10750/3250=3.3. In another case, it is assumed that for all the devices that click AC3, there are 600 groundtruth devices whose users are male, 400 groundtruth devices whose users are female, 20000 unknown devices whose users are male, and 10000 unknown devices whose users are female according to the above-mentioned steps, then there are 20600 devices whose users are male and 10400 devices whose users are female, and the update campaign gender distribution ratio of AC3 is 20600/10400=1.98. In another case, it is assumed that for all the devices that click AC4, there are 400 groundtruth devices whose users are male, 800 groundtruth devices whose users are female, 5000 unknown devices whose users are male, and 20000 unknown devices whose users are female according to the above-mentioned steps, then there are 5400 devices whose users are male and 20800 devices whose users are female, and the update campaign gender distribution ratio of AC4 is 5400/20800=0.25. In this manner, the update campaign gender distribution ratios for each advertising campaign can be obtained.

Step 108: compare a quadratic sum of the difference of the old and update campaign gender distribution ratios with a second certain value for each advertising campaign. For example, since the campaign gender distribution ratio of AC1 is 0.25 and the update campaign gender distribution ratio of AC1 is 0.26, the quadratic sum of the difference of the old and update campaign gender distribution ratios is (0.25-0.26)²=0.0001; since the campaign gender distribution ratio of AC2 is 3 and the update campaign gender distribution ratio of AC2 is 3.3, the quadratic sum of the difference of the old and update campaign gender distribution ratios is (3-3.3)²=0.09; since the campaign gender distribution ratio of AC3 is 1.5 and the update campaign gender distribution ratio of AC3 is 1.98, the quadratic sum of the difference of the old and update campaign gender distribution ratios is (1.5-1.98)²=0.2304; since the campaign gender distribution ratio of AC4 is 0.5 and the update campaign gender distribution ratio of AC4 is 0.25, the quadratic sum of the difference of the old and update campaign gender distribution ratios is (0.5-0.25)²=0.0625. In a case that there are only four advertising campaigns, the sum is 0.0001+0.09+0.2304+0.0625=0.383. A second certain value is used to determine if the process should stop or not. It will be described in the following step.

Step 110: back to the assigning step (Step 104) if the quadratic sum is greater than a second certain value, and end the process if the quadratic sum is less than the second certain value. For example, it is assumed that the second certain value is 10 (which can be any suitable value for determination), in the above-mentioned example, the sum is less than the second certain value (0.383 <10), there the process stops. Otherwise, back to Step 104 to calibrate the campaign gender distribution ratios of each advertising campaign so as to enhance the accuracy to predict the gender of a network user.

In a preferred embodiment, when the campaign gender distribution ratio of the advertising campaign is abnormal, a given value may be directly assigned to an advertising campaign. For example, it is assumed that the campaign gender distribution ratio of a Gundam animation advertisement campaign is 0.5 (as we have discussed above, the value which is smaller than 1 is normally for a feminine campaign gender distribution ratio), it is abnormal, then this value may be replaced by a reasonable masculine campaign gender distribution ratio (for example, 3). In this manner, the inaccuracy data can be amended and the accuracy of predicting the gender of network users can be enhanced.

While various exemplary embodiments of the present invention are described herein, it should be noted that the present invention may be embodied in other specific forms, including various modifications and improvements, without departing from the spirit and scope of the present invention. Thus, the described embodiments are to be considered in all respects only as illustrative and not restrictive.

What is claimed is:

1. A method of enhancing the accuracy to predict the gender of a network user, comprising the steps of:
obtaining campaign gender distribution ratios for each advertising campaign by counting the gender information of groundtruth devices which clicked in the respective advertising campaigns;
assigning the gender information for each unknown device by finding out the advertising campaigns that are clicked by the unknown device, multiplying the campaign gender distribution ratios of the clicked advertising campaigns, and comparing the multiplied result with a first certain value;
obtaining update campaign gender distribution ratios for each advertising campaign by counting the gender information of groundtruth devices and unknown devices which clicked in the respective advertising campaigns; and
comparing a quadratic sum of the difference of the old and update campaign gender distribution ratios with a second certain value for each advertising campaign, and back to the assigning step if the quadratic sum is greater than a second certain value.

2. A method according to claim 1, wherein a given value may be directly assigned to an advertising campaign if the campaign gender distribution ratio of the advertising campaign is abnormal.
